(19) United States
(12) Patent Application Publication
(10) Pub. No.: US 2011/0084547 A1
(43) Pub. Date: Apr. 14, 2011

(54) FRICTION-WELDED COMPOUND LINK

(75) Inventors: Dirk EHRLICH, Bodenheim (DE); Gerd BITZ, Mainz (DE)

(73) Assignee: GM GLOBAL TECHNOLOGY OPERATIONS, INC., Detroit, MI (US)

(21) Appl. No.: 12/902,900

(22) Filed: Oct. 12, 2010

(30) Foreign Application Priority Data
Oct. 12, 2009 (DE) 102009049117.1

(51) Int. Cl. B60B 35/06; B23K 20/12

(52) U.S. Cl. 301/127; 228/112.1

(57) ABSTRACT

Introduced is a compound crank axle having a flexurally stiff and torsionally soft cross member, on whose ends two trailing links are arranged. The respective ends of the cross member are joined with the trailing links through friction welding in an angularly stiff manner. Here, the trailing links joined with the cross member are held together at a common transition region which is created in that both trailing links are joined together simultaneously and evenly with the cross member in a materially connected manner through friction welding.

### CROSS-REFERENCE TO RELATED APPLICATION

This application claims priority to German Patent Application No. 102009049117.1, filed Oct. 12, 2009, which is incorporated herein by reference in its entirety.

### TECHNICAL FIELD

The invention relates to a compound link and more particularly to a compound link for the rear axle of a passenger car and a method for producing such a compound link, wherein individual components are welded together.

### BACKGROUND

Compound crank axles have already been known for some time. The compound crank rear axle has proved itself as the most economical design for non-driven rear axles. Two guiding trailing links are connected to each other via a cross member, which simultaneously serves as stabilizer. Advantages of this design are the favorable lateral guidance when driving through curves and a low favorable space requirement that allows favorable space distribution in the rear.

However, in order to evenly introduce the high torsion and bending moments alternately acting on the cross member while driving into the trailing links, the respective trailing link is designed unitarily with a provided shoulder that fits the cross member shaped as a tube. Such a compound crank rear axle has a high load-carrying capacity but on the other hand has a relatively large weight since its trailing links have to be produced of a ferrous metal weldable to the antiroll bar.

In order to be able to use light metals, EP 0 774 369 B1 for example proposes to positively cast or mold the above-mentioned shoulders into a basic body of the trailing link. However, elaborate production steps are necessary for this purpose which is reflected in substantially higher costs. A further solution is proposed in DE 197 52 347 A1, where the links produced of light metal alloys are inserted into each other in a transition region and joined together by an adhesive. This solution is also involves a multiplicity of production steps and requires a plurality of individual parts which have to be joined together in order to ensure a positive connection, which has to satisfy the dynamic forces that occur.

In view of the foregoing, at lease one object is to further develop a compound crank rear axle such that it can be produced cost-effectively and despite few components and weight optimization is sufficiently sturdy and safe and to provide a corresponding method for its manufacture. In addition, other object, desirable features, and characteristics will become apparent from the subsequent summary and detailed description, and the appended claims, taken in conjunction with the accompanying drawings and this background.

### SUMMARY

A compound link is provided having a flexurally stiff and torsionally soft cross member at whose ends two trailing links are arranged, wherein the respective ends of the cross member are joined with the trailing links through friction welding in an angularly stiff manner.

It is desirable to select a flexurally stiff but torsionally soft steel profile for the cross member which is designed to react rigidly to transverse and longitudinal forces acting on the wheels while simultaneously acting in a stabilizing manner to bump and rebound spring movements acting in vehicle height direction. These characteristics are also utilized in favor of the compound link.

As usual, the trailing links in turn are suitable at an end for accommodating wheel carriers and these can be articulated on their other end on a vehicle body. Here, the trailing links connected to the cross member are held together at a common contact region which is created in that both trailing links are simultaneously and evenly joined with the cross member through friction welding in a materially connected manner.

This embodiment still allows making use and also process trailing links of light metal. With the popular welding method such as for example magnetic arc welding method—magnetically moved arc—joining of cross members of steel and trailing links cannot be performed.

According to an embodiment of the invention, such a design allows substantially simplifying the manufacture and assembly of the compound crank rear axle since the trailing links together with the cross member can be automatically and simultaneously welded together on the welding stand in one pass—without additional prefabricating steps.

During the course of the improvement of the driving characteristics of a passenger car lighter, rear axles can be designed by means of different materials. This weight reduction is an advantage compared with conventional rear axles since with the reduction of the weight the driving characteristics of the passenger cars can be improved at the same time—and that with approximately equal or higher strength and load-carrying capacity compared with conventional rear axles.

The trailing link can be manufactured relatively easily and cost-effectively from an aluminum and/or magnesium alloy with suitable methods.

A further improvement of the joining of cross member and trailing link is that the transition region around a contact area of the respective components is surrounded by a sealing or corrosion protection agent. In this manner, possible corrosion or rust formation is avoided in these areas.

The durability of the compound crank rear axle can be even further increased if the cross member alone and/or the trailing links are treated or coated with a corrosion protection agent. Known coatings of aluminum, zinc or similar material are suitable for this for example. A further favorable possibility is a surface protection on plastic basis.

Preferentially, two contact areas to be welded together each comprise a complementary area so that the joining process can be configured preferably effectively and in a time-saving manner. In addition an even positive connection is also achieved.

In another embodiment of the invention the wall thicknesses and diameters of the contact areas to be welded together have approximately identical dimensions. This ensures more even heating of both components and also better joining as a result.

If with the process according to the invention rotary friction welding is employed, the joining zone comprises a contact cross section in the region of or in a welding point joining the cross member of a rotationally symmetrical shape.

The proposed manufacturing method for the compound crank axle utilizes the advantage of the friction welding method in that it makes possible the permanent connecting—joining—of two different materials in few operating steps. During friction welding, two parts are moved relative to each other, wherein the parts contact each other on contact surfaces. Through the resultant friction, heating takes place. At the end of the friction process the parts are positioned correctly to each other and high pressure is exerted. The advantage of this method is that the so-called heat influence zone is significantly smaller than with other welding methods.

With the method, so-called rotary friction welding can be employed, which is a pressure welding method. Here, one of the joining parts can comprise a rotationally symmetrical configuration in the joining zone—in this case the two ends of the cross member. The energy supply is exclusively supplied through relative movement of the joining parts under pressure. In an embodiment the two stationary trailing links are simultaneously and evenly pressed against the cross member rotating about its longitudinal axis.

An advantage resulting from the method is the possibility of attaching both trailing links to the cross member with maximum accuracy and under equal conditions. Here, the adjustment of any angle of rotation of the trailing links about a longitudinal axis is possible without major effort.

It is also time-saving and cost-effective here that the surfaces of the components used which come in contact need not be pre-processed—smoothed. A rough contact surface can be friction-welded without major effort. Added to this is that the clock cycles of the welding process are very short compared to other methods and productivity can thus be increased.

In addition to this, an advantage of the friction welding method in the manufacture of compound crank axles is that different material combinations and/or different material qualities can be processed. Steel with aluminum or magnesium alloys are joined together into a compound crank axle in a materially connected manner. By forming an even welding bead in the joining zone of the contact area even material transition and thus a materially connected joint is guaranteed.

It is to be understood that the features mentioned above and still to be explained in the following cannot only be configured in the respective combination stated but also in other combinations—arrangements acting in a complementary manner.

### BRIEF DESCRIPTION OF THE DRAWINGS

The present invention will hereinafter be described in conjunction with the following drawing figures, wherein like numerals denote like elements, and:

FIG. 1 a basic sketch of a compound crank rear axle according to an embodiment of the invention; and

FIG. 2 a basic sketch of a longitudinal section through a compound axle according to an embodiment of the invention of a surface running through an axis of rotation of the cross member.

### DETAILED DESCRIPTION

The following detailed description is merely exemplary in nature and is not intended to limit application and uses. Furthermore, there is no intention to be bound by any theory presented in the preceding background or summary or the following detailed description.

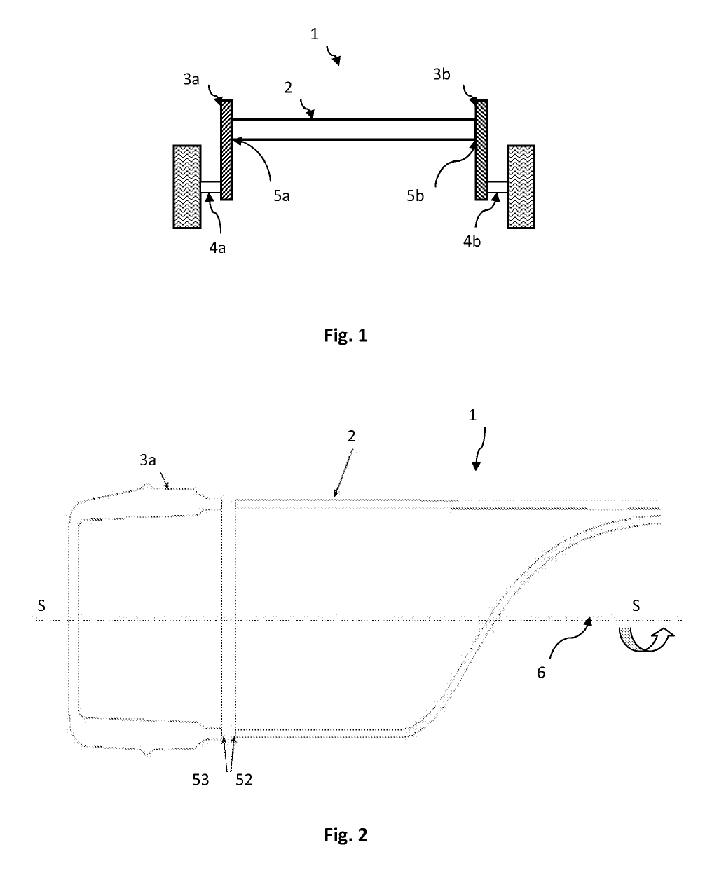

FIG. 1 is a basic sketch of a compound crank axle 1 according to an embodiment of the invention comprising a cross member 2 at whose outer ends a wheel-guiding trailing link 3a, 3b each is connected in an angularly stiff manner. The trailing links 3a, 3b are preferentially of a light metal alloy and at one end comprise a wheel carrier and on the other end of the trailing link 3a, 3b opposite the wheel carrier, a bearing eye—which is not shown—elastically articulated on a vehicle body.

The sectional view of FIG. 2 through an axis of rotation of the cross member 2 illustrates the contact areas 52, 53 of a cross member 2 and of a trailing link 3a before the friction welding process. From the basic sketch of the contact area 52 of the cross member illustrated in FIG. 2 and a contact area 53 of the trailing link it can be seen that in a preferred embodiment of the invention the wall thicknesses and diameters of the contact areas 52 and 53 to be welded are approximately equal. This ensures more even heating of both components and thus also a better joint. In addition it is indicated in FIG. 2 that only the cross member 2 is rotated relative to the two trailing links 3a and 3b—here only shown for one trailing link 3a, while the trailing link is stationary in a rotationally fixed manner and securely clamped is pressed against the cross member 2. Because of this it can be ensured that both trailing links 3a, 3b are heated simultaneously and evenly. As soon as the contact areas 53, 54 are hot enough the two trailing links 3a, 3b are pressed against the cross member 2 with increased upsetting pressure for the last time, as a result of which the two components are joined together in a materially connected manner. In this manner it is possible to join components of different quality and materials. Because of the friction welding process a joining zone, which is not shown—i.e., the contact areas 52, 53, have merged with each other—has a rotationally symmetrical shape. In this manner, a cost-effective and high-quality compound crank axle more preferably for passenger cars can be produced.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A compound crank axle, comprising:
a flexurally stiff and torsionally soft cross member;
two trailing links arranged on ends of the flexurally stiff and torsionally soft cross member,
wherein the ends of the flexurally stiff and torsionally soft cross member are joined with the two trailing links through friction welding in an angularly stiff manner.

2. The compound crank axle according to claim 1, wherein the two trailing links are formed of a light metal alloy.

3. The compound crank axle according to claim 2, wherein the light metal alloy is an aluminum alloy.

4. The compound crank axle according to claim 2, wherein the light metal alloy is a magnesium alloy.

5. The compound crank axle according to claim 1, wherein the two trailing links are formed of cast iron.

6. The compound crank axle according to claim 1, wherein the flexurally stiff and torsionally soft cross member is formed of a steel material.

7. The compound crank axle according to claim 1, wherein the flexurally stiff and torsionally soft cross member is formed of a casting material.

8. The compound crank axle according to claim 1, wherein at least one contact region of the flexurally stiff and torsionally soft cross member and at least one of the two trailing links is coated with a corrosion protection agent.

9. The compound crank axle according to claim 1, wherein at least one contact region of the flexurally stiff and torsionally soft cross member and at least one of the two trailing links is treated with a corrosion protection agent.

10. The compound crank axle according to claim 1, wherein link contact areas of the two trailing links to be welded are each formed complementarily to cross member contact areas of the flexurally stiff and torsionally soft cross member.

11. The compound crank axle according to claim 10, wherein the link contact areas to be welded have substantially similar wall thickness.

12. The compound crank axle according to claim 10, wherein the link contact areas to be welded have substantially similar wall diameters.

13. The compound crank axle according to claim 1, wherein a contact cross section in a region of a welding point joining the flexurally stiff and torsionally soft cross member has a rotationally symmetrical shape.

14. A method for manufacturing a compound crank axle, comprising the steps of:
providing a flexurally stiff and torsionally soft cross member;
arranging two trailing links on ends of the flexurally stiff and torsionally soft cross member; and
friction welding the ends of the flexurally stiff and torsionally soft cross member to the two trailing links in an angularly stiff manner.

15. The method according to claim 14, further comprising joining the two trailing links in a substantially simultaneously with the flexurally stiff and torsionally soft cross member in a materially connected manner.

16. The method according to claim 14, further comprising joining the two trailing links substantially evenly with the flexurally stiff and torsionally soft cross member in a materially connected manner.

17. The method according to claim 14, wherein only the flexurally stiff and torsionally soft cross member is rotated about a longitudinal axis relative to the two trailing links.

18. The method according to claim 14, wherein the two trailing links can be formed at an angle of rotation about a longitudinal axis of the flexurally stiff and torsionally soft cross member.

19. The method according to claim 14, further comprising welding rough contact surfaces.

20. The method according to claim 14, wherein a transition region from the flexurally stiff and torsionally soft cross member to a respective trailing link of the two trailing links is effected subject to a formation of an even welding bead.
